(19) United States
(12) Patent Application Publication
(10) Pub. No.: US 2018/0315013 A1
(43) Pub. Date: Nov. 1, 2018

(54) SYSTEMS AND METHODS FOR MONITORING RETAIL ITEM DISTRIBUTION DURING ITEM DELIVERY TO A CUSTOMER'S VEHICLE

(71) Applicant: Walmart Apollo, LLC, Bentonville, AR (US)

(72) Inventors: Bruce W. Wilkinson, Rogers, AR (US); Todd D. Mattingly, Bentonville, AR (US)

(21) Appl. No.: 15/928,415

(22) Filed: Mar. 22, 2018

Related U.S. Application Data
(60) Provisional application No. 62/492,772, filed on May 1, 2017.

(51) Int. Cl. G06Q 10/08; G05D 23/19

(52) U.S. Cl. CPC G06Q 10/0832; G05D 23/1917

(57) ABSTRACT

In some embodiments, apparatuses and methods are provided herein useful for receiving retail items at a vehicle. In some embodiments, there is provided a system for receiving retail items at a vehicle including a portable retail container configured to store one or more retail items; a cloud-based database comprising a lookup database storing, for each of the plurality of retail items, an association with at least one of: a temperature range of a plurality of temperature ranges, or one of the one or more compartments of the portable retail container; and the control circuit configured to: access the lookup database to determine for each of the retail items at least one of: an associated temperature range or a compartment of the one or more compartments; and assign each of the one or more retail items to a corresponding compartment based on the determined temperature range or the determined compartment.

### CROSS-REFERENCE TO RELATED APPLICATION

This application claims the benefit of U.S. Provisional Application No. 62/492,772, filed May 1, 2017, which is incorporated herein by reference in its entirety.

### TECHNICAL FIELD

This invention relates generally to receiving retail items at a vehicle.

### BACKGROUND

Generally, when a customer submits a retail order for a retail item, the customer indicates on the retail order where and/or to whom to deliver the retail item. Depending on instructions indicated on the retail order, a delivery agent may generally deliver the retail item to the indicated delivery location (e.g., at a home or a place of work of the customer). In most cases, the delivery agent may either leave the retail item at a door or a mailbox of the home or the place of work, or hand the retail item to the customer or a person authorized to receive the retail item. However, there may be times when neither one of these options are preferable by the customer or even possible given circumstances at the time of the delivery.

### BRIEF DESCRIPTION OF THE DRAWINGS

Disclosed herein are embodiments of systems, apparatuses and methods pertaining to receiving retail items at a vehicle. This description includes drawings, wherein:

FIG. 1 illustrates a simplified block diagram of an exemplary system for receiving retail items at a vehicle in accordance with some embodiments;

FIG. 2 is a simplified schematic illustration of an exemplary portable retail container in accordance with some embodiments;

FIG. 3 shows a flow diagram of an exemplary process of receiving retail items at a vehicle in accordance with some embodiments;

FIG. 4 shows a flow diagram of an exemplary process of receiving retail items at a vehicle in accordance with some embodiments; and

FIG. 5 illustrates an exemplary system for use in implementing methods, techniques, devices, apparatuses, systems, servers, sources, and receiving retail items at a vehicle, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for receiving delivered retail items at a vehicle. In some embodiments, a system for receiving retail items at a vehicle includes a portable retail container configured to store one or more retail items delivered by a delivery agent. The portable retail container may be operably coupled to the vehicle and comprises one or more compartments. By one approach, the system may include a cloud-based database including a lookup database operably coupled to a control circuit. For each of a plurality of retail items, the lookup database may store an association with at least one of: a temperature range of a plurality of temperature ranges, or one of the one or more compartments of the portable retail container. By another approach, the system may include the control circuit coupled with the portable retail container. The control circuit may access the lookup database to determine for each of the one or more retail items at least one of: an associated temperature range or a compartment of the one or more compartments. In one configuration, each of the one or more compartments is associated with a particular assigned temperature range. The control circuit may also assign each of the one or more retail items to a corresponding compartment of the one or more compartments based on the determined temperature range or the determined compartment.

In some embodiments, there is provided a method for receiving retail items at a vehicle. The method includes accessing, by a control circuit, a cloud-based database to determine for each of one or more retail items at least one of: an associated temperature range or a compartment of one or more compartments of a portable retail container. The portable retail container may store the one or more retail items. By one approach, the cloud-based database may include a lookup database, where each of the one or more compartments is associated with a particular assigned temperature range. The method may include assigning, by the control circuit, each of the one or more retail items to a corresponding compartment of the one or more compartments based on the determined temperature range or the determined compartment.

In some embodiments, a system for receiving retail items at a vehicle includes a portable retail container including one or more compartments. The portable retail container may be operably coupled to the vehicle. By one approach, the portable retail container may store one or more retail items delivered by a delivery agent and receive power from a car battery of the vehicle. In some embodiments, the system may include a control circuit coupled with the portable retail container. In one instance, the control circuit may be integrated with the portable retail container. In another instance, the control circuit may be independent of the portable retail container.

In one configuration, the control circuit may access a lookup database to determine for each of the one or more retail items at least one of: an associated temperature range or a compartment of the one or more compartments. In some instances, each of the one or more compartments may be associated with a particular assigned temperature range. Further, the control circuit may assign each of the one or more retail items to a corresponding compartment of the one or more compartments based on the determined temperature range or the determined compartment. In some instances, the control circuit may determine whether a voltage output of the power received from the car battery is sufficient to power the portable retail container based on a voltage threshold.

In some embodiments, a system is disclosed for receiving, at a vehicle, retail items ordered by a customer. In an illustrative non-limiting example, the customer may have indicated on a retail order or at a later time that one or more retail items are to be delivered to the vehicle associated with the customer due to the customer unable to physically receive the retail items and, instead, prefers that a delivery agent delivers the retail items into a portable retail container cooperated with the vehicle. The portable retail container may be located on a roof, in an interior, in a trunk of the vehicle, or otherwise cooperated with the vehicle, and typically secured with the vehicle. In some instances, the portable retail container may be operably coupled to an on-board remote access system of the vehicle via wireless and/or wired connection using Bluetooth, Ethernet, and/or USB communication, among other types of communication protocols that may be used to connect one device with another device. The portable retail container may also be coupled to a battery of the vehicle. The coupling may be through the on-board remote access system and/or a separate wired connection between the portable retail container and the battery.

By one approach, the delivery agent may remotely gain access to the vehicle based on one or more access codes associated with the retail order. The access codes may have been provided by the customer when the retail order was submitted or otherwise provided by the customer (e.g., at the time the customer submitted the request that the one or more items be delivered to the vehicle). In another scenario, the access codes may be associated with a customer profile of the customer and accessible to the delivery agent and/or a retail entity directing the delivery. In yet another scenario, the access codes may be provided by the customer or the control circuit associated with the portable retail container when the delivery agent is at or near the vehicle. For example, a device interface associated with an electronic device of the delivery agent may automatically send an access code request message to an electronic device associated with the customer when the device interface, through the electronic device of the delivery agent, detects a geofence associated with the portable retail container. By one approach, the geofence of the portable retail container may be included in the retail order and/or associated with a customer profile of the customer. In response to the access code request message, the customer may provide the access code to the delivery agent via a device interface associated with the electronic device of the customer.

In any of the above-described scenarios, the delivery agent receives the access codes through an electronic device associated with the delivery agent. Subsequently, one or more of the access codes are used by the delivery agent to access the vehicle and/or the portable retail container. In one instance, the electronic device associated with the delivery agent may communicate with the portable retail container and/or the on-board remote access system to remotely gain access to the vehicle for delivery of the retail items into the portable retail container. In another instance, the delivery agent may enter one or more of the access codes through a user interface of the retail container (e.g., a display interface and/or a keypad, among other means of entering the access codes to gain access to the portable retail container).

In one configuration, the portable retail container may have one compartment that stores the retail items to be delivered by the delivery agent. The delivery agent may receive through the electronic device associated with the delivery agent one or more messages indicating a temperature range associated with each of the retail items to be delivered. Prior to the delivery of the retail items, the control circuit may determine a particular temperature range to be assigned with the one compartment, where the particular temperature range is a proper storage temperature for the retail items based, in part, on what type of products are the retail items and/or number of items in the retail items.

For example, the control circuit may access a cloud-based database of a memory device to determine the particular temperature range. By one approach, the cloud-based database may include a lookup database and an access code database. The cloud-based database may include a listing and/or a correlation of recommended temperature(s) and/or temperature ranges associated with various retail items based on one or more standards/recommendations from one or more government agencies and/or organization(s) concerned with food safety standards on storage temperatures of various retail items. As such, the proper storage temperature may correspond to a temperature that is within a threshold range of recommended temperature(s) and/or temperature ranges for one or more retail items. The proper storage temperature may be based on a temperature or temperature range that overlaps the recommended temperature(s) and/or temperature ranges for the one or more retail items.

Thus, the control circuit may adjust the temperature of the one compartment to fall within the determined particular temperature range. As such, the temperature of the one compartment is already within the particular temperature range when the delivery agent delivers the retail items into the portable retail container. Alternatively or in addition to, upon delivering the retail items into the portable retail container and determining the current temperature of the one compartment, the delivery agent may adjust the current temperature of the one compartment to fall within the determined particular temperature range via the electronic device associated with the delivery agent and/or a display device of the portable retail container.

In another configuration, the portable retail container may have two or more compartments for storage of the retail items ordered by the customer. In such configuration, the electronic device associated with the delivery agent may receive one or more messages indicating allocation of each of the retail items to a particular compartment of the portable retail container. If the delivery agent may have incorrectly placed a retail item in a compartment, the control circuit may send an alert message to the electronic device associated with the delivery agent indicating that the retail item has been placed in a wrong compartment. By one approach, the control circuit may include in the alert message the correct compartment to place the retail item. For example, the delivery may have placed a bucket of ice cream in a first compartment of the portable retail container. However, a message received by the delivery agent may indicate that the bucket of ice cream is allocated to a second compartment of the portable retail container. Thus, the delivery agent incorrectly placed the bucket of ice cream in the wrong compartment. As such, the control circuit may send an alert message to the electronic device associated with the delivery agent indicating that the bucket of ice cream is in the wrong compartment. The alert message may also indicate the correct compartment to place the bucket of ice cream. By another approach, the control circuit may provide an alert signal to an alarm sensor of the portable retail container. In one configuration, the alert signal may trigger the alarm sensor to emit an audible alarm to alert the delivery agent of an incorrect placement of a retail item in a compartment (e.g., the placement of the bucket of ice cream in the wrong compartment).

By one approach, the control circuit may access the lookup database to determine particular allocations of retail items to compartments of the portable retail container. In one configuration, the lookup database may store information indicating association of one or more retail items to one or more temperature ranges. A temperature range may correspond to a proper storage temperature of a retail item. As such, the lookup database may include associations of one or more temperature ranges with one or more retail items. The one or more retail items in the lookup database may be retail items for sale and/or part of an inventory of a retail store. As such, each time the retail store acquires a retail item for sale and/or placed in an inventory, the lookup database may be updated to include the newly acquired retail item and/or the mapping of the retail item to a particular temperature range suitable for proper storage of the newly acquired retail item.

Moreover, the lookup database may store information indicating association of a retail item to a compartment of the portable retail container. As such, each of the compartments of the portable retail container may be dynamically assigned a particular temperature range by the control circuit based, at least in part, on the stored information in the lookup database and the retail items associated with a retail order. By one approach, the control circuit may assign and/or reassign one or more temperature ranges associated with each compartment based, in part, on products associated with the retail items of the retail order. Thus, based on a retail order submitted by the customer, the control circuit may adjust a temperature associated with one or more compartments of the portable retail container to fall within a corresponding particular temperature range based on the retail items associated with the submitted retail order.

For example, the control circuit may provide a temperature-set data to a thermostat of the portable retail container to adjust the temperature associated with the one or more compartments. In such configuration, the thermostat may control a heating, ventilation, and air conditioning (HVAC) system of the portable retail container to bring the temperature of the one or more compartments to fall within the corresponding particular temperature range based on the retail items associated with a submitted retail order. The thermostat may also control the HVAC system to maintain the temperature of the one or more compartments within the corresponding particular temperature range. Alternatively or in addition to, the control circuit may activate and/or operate, in cooperation with one or more sensors configured to provide temperature data, the HVAC system to maintain within the corresponding particular temperature range and/or to bring the temperature of the one or more compartments to fall within the corresponding particular temperature range.

A non-limiting illustrative example of a retail order may include a package of raw chicken wings, a gallon of milk, and a pint of blueberries. In such illustrative non-limiting example, the control circuit may access the lookup database to determine proper storage temperature for each item in the retail order. To illustrate, information stored in the lookup database may indicate that proper storage temperature for raw chicken is a temperature below 40 degrees farenheit (° F.), cooked chicken is a temperature above 140° F., milk is a temperature below 40° F., and blueberries is a temperature below 50° F. By one approach, the control circuit may assign a temperature range of 30° F. to 40° F. to a first compartment and assign a threshold temperature of below 40° F. to a second compartment. As such, the control circuit may specify the temperatures of the two compartments based on the stored information in the lookup database regarding recommended temperatures and/or temperature ranges for the retail items in the retail order.

For example, the control circuit may adjust the temperature of the first compartment to 35° F. and maintain the temperature within the 30° F. to 40° F. range for proper storage of the raw chicken wings. In another example, the control circuit may adjust the temperature of the second compartment to 35° F. to receive the milk and may readjust the temperature when the temperature is greater than or equal to 40° F. to maintain the temperature below 40° F. Thus, temperatures assigned to compartments of the portable retail container may be based on types/kinds of products associated with the retail items, number of retail items in the retail order, and/or number of compartments available in the portable retail container. In such example of a portable retail container having two compartments, the control circuit may send a message to the electronic device associated with the delivery agent instructing the delivery agent to place the package of raw chicken wings in the first compartment and instruct that the gallon of milk and the pint of blueberries be placed in the second compartment.

By another approach, information stored in the lookup database may indicate associations of each of the retail items with a particular compartment. In an illustrative non-limiting example, each compartment of a portable retail container may have a predetermined temperature range. Thus, information stored in the lookup database may include associations of one or more retail items to one or more compartments of a particular portable retail container. As such, the lookup database may store information for a number of portable retail containers that are associated with various models. For example, each model of a portable retail container may be associated with a portable retail container having a particular number of compartments. In an illustrative non-limiting example, the lookup database may store a plurality of associations of predetermined temperature ranges, compartments, and various product models of a plurality of portable retail containers. For example, in the lookup database, a particular model of a portable retail container may be associated with having three compartments. Further, in the lookup database, each of the three compartments of the particular model may be associated with a particular predetermined temperature range. Thus, by one approach, prior to assigning each of the retail items in a retail order to a particular compartment of a particular model of a portable retail container, the control circuit may access the lookup database and may determine that each compartment of the portable retail container associated with the particular model may have a predetermined temperature range. In response, the control circuit, may assign each of the retail items to one of the three compartments having a predefined temperature range, where the assignment of each retail item is consistent with the proper storage temperature for that retail item.

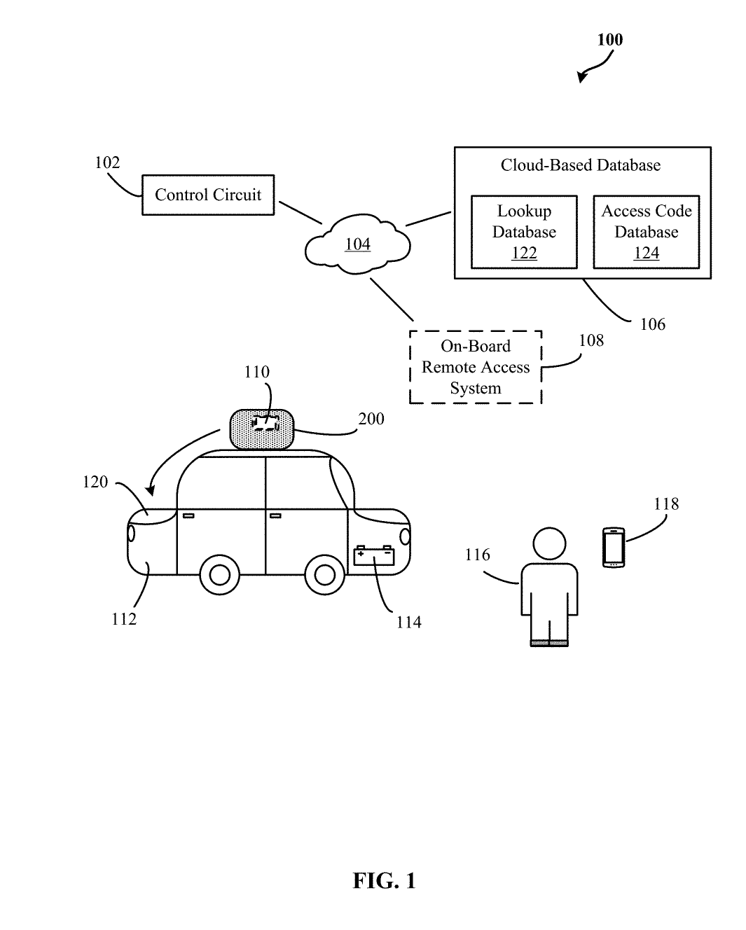

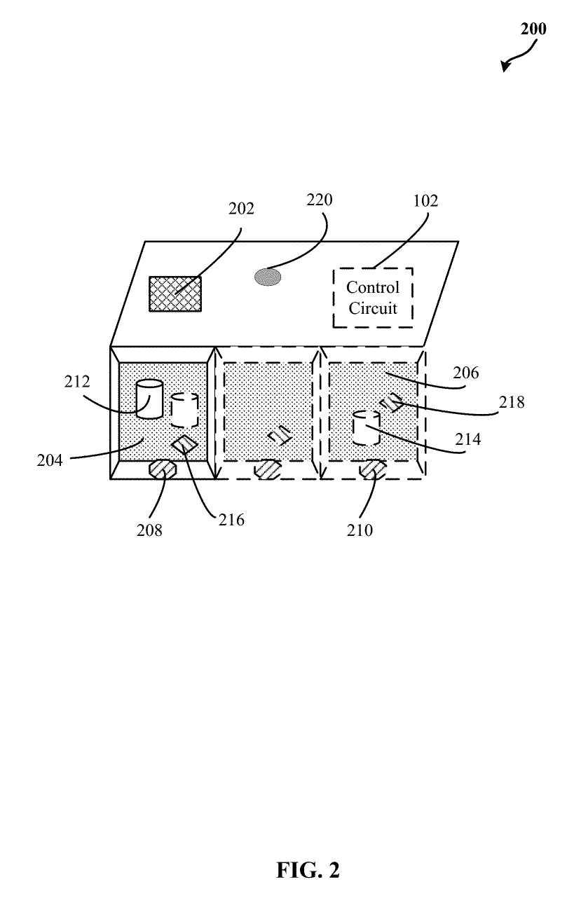

To further illustrate, FIGS. 1-5 are described herein as an illustrative non-limiting illustration in accordance with some embodiments. FIG. 1 and FIG. 2 illustrate an exemplary system for receiving retail items at a vehicle. FIG. 1 shows a simplified block diagram of an exemplary system 100 that includes multiple portable retail containers 200, and FIG. 2 shows a simplified schematic illustration of an exemplary portable retail container 200. The system 100 includes the portable retail containers 200 that store one or more retail items 212, 214 delivered by a delivery agent 116. In one instance, the retail items 212, 214 may be associated with a retail order submitted by a customer. Each of the retail items 212, 214 may correspond to one or more number of retail items. For example, a sirloin steak, a small basket of strawberries, a can of tomatoes, and/or a container of cottage cheese, among other examples of retail items. The delivery agent 116 may be associated with an electronic device 118. In one instance, the delivery agent 116 may comprise at least one of: an associate of a retail store, a crowd-sourced delivery agent, a customer of the retail store, a contractor to the retail store, and/or other individuals or entities who have agreed to make a delivery for the retail store.

In one configuration, the portable retail container 200 may include one or more compartments 204, 206 enclosed in an insulated housing. The one or more compartments 204, 206 are separated by one or more dividers (not shown) to separate one compartment from another compartment. In one configuration, the control circuit 102 may be integrated with the portable retail container 200 along with the HVAC system, a power source, a power coupler to couple to a car battery, and/or a wired and/or wireless transceiver, among other components expected of a functioning device. In another configuration, the control circuit 102, the HVAC system, the power source, the power coupler, and/or the wired and/or wireless transceiver, among the other components, may be housed in a separate housing secured with the portable retail container 200.

By one approach, the portable retail container 200 may be operably coupled to a vehicle 112 and may comprise the one or more compartments 204, 206. In one instance, the portable retail container 200 may be located on a roof of the vehicle 112 as shown in FIG. 1. In another instance, the portable retail container 200 may be located in a trunk 120, in an interior of the vehicle 112, in the back-bed of a pick-up truck, or other such location of the vehicle. In some embodiments, the portable retail container 200 is configured to be movable or portable by an average strength individual from one location to another, for example, from the roof (as shown) to the trunk 120. Typically, the retail container includes one or more retail item identifier systems, such as one or more RFID tag readers configured to read RFID tags providing unique identifiers of the corresponding product, one or more optical scanners (e.g., bar code scanner), one or more camera systems and image/video processing systems, other such identifier systems, or combination of two or more of such item identifier systems. The portable retail container 200 may, for example, include one or more reader antennas 208, 210 with at least one of the reader antennas 208, 210 being associated with each of the one or more compartments 204, 206. In one configuration, the portable retail container 200 may include one or more tag readers 202 coupled with the one or more reader antennas 208, 210. In one instance, the tag reader 202 may wirelessly detect one or more tags that are each associated with one of the retail items 212, 214 through the reader antennas 208, 210. For example, the can of tomatoes may be associated with a first tag and the basket of strawberries may be associated with a second tag. By one approach, the first and second tags are read by the tag reader 202 through one of the reader antennas 208, 210 when the delivery agent 116 places the can of tomatoes and the basket of strawberries in their respective assigned compartments. The portable retail container 200 includes one or more sensors 216, 218 associated with one or more of the compartments. The sensors can include one or more of temperature sensors, light sensors, motion sensors, infrared sensors, weight and/or pressure sensors, and/or other such sensors. For example, a different temperature sensor may be cooperated with each of the compartments and configured to read a temperature associated with a respective one of the compartments 204, 206.

The control circuit 102, in some embodiments, is further configured to keep track of the time the retail items 212, 214 have been stored in the portable retail container 200. The timing may be based on an opening of the compartment, a notification from a delivery agent of a delivery of an item, the detection of an item placed in the compartment (e.g., one or more tags read by the tag reader 202), or the like. In one instance, the control circuit 102 may store, via a memory, an initial time when a tag is initially read by the tag reader 202. The control circuit 102 may determine that a retail item associated with the tag is still inside the portable retail container 200 based on the lack of subsequent read of the tag corresponding to the item being removed when the tag reader is positioned to read tags at an opening. As such, the control circuit 102 may determine a length of time the retail item has been stored in the portable retail container 200 based on the initial time the tag is read and a time of inquiry regarding the length of time the retail item has been stored. In another instance, the control circuit 102 may periodically perform a reading of tags in the portable retail container 200 to determine which of the retail items 212, 214 are still in the portable retail container 200 when the tag reader is positioned to read tags within the compartment. As such, the control circuit 102 may determine a length of time the retail item has been stored in the portable retail container 200 based on time of initial read of the tag and the time of most current read of the tag.

In an illustrative non-limiting example, a customer submits a retail order for retail items that includes a package of raw chicken wings, a gallon of milk, and a pint of blueberries. The retail order may also include instructions to the delivery agent 116 to deliver the retail items to the portable retail container 200 that is located inside the trunk 120 of the vehicle 112. In other instances, a subsequent request may be communicated by the customer requesting the delivery be routed to the portable retail container 200 and the vehicle 112. By one approach, a location of the portable retail container 200 and the vehicle 112 may be included with the retail order. For example, during a submission of the retail order, the customer may include a location corresponding to an address with the retail order. The address may correspond to a physical address of a house, a workplace, or a place the customer may choose to have delivered, at a particular time, retail items associated with the retail order. Alternatively or in addition to, the address may correspond to a device identifier (e.g., geofence) associated with the portable retail container 200 and/or the vehicle 112. In one configuration, the electronic device 118 may determine the location of the portable retail container 200 and/or the vehicle 112 based on the device identifier. As such, the location of the portable retail container 200 and/or the vehicle 112 may be periodically updated and/or provided to the electronic device 118 based on a particular location of the device identifier during a delivery. In one configuration, the periodical update of the location of the portable retail container 200 and/or the vehicle 112 may start on the day of the delivery and/or a period of time of the delivery.

By another approach, the location of the portable retail container 200 and the vehicle 112 may be subsequently communicated and/or updated by the customer to the delivery agent 116. By another approach, the geofence of the vehicle 112 may be included in the retail order such that a device interface associated with the electronic device 118 may send a message, an alarm, an indication, and/or the like, when the delivery agent 116 is a threshold distance from the geofence of the vehicle 112. As such, when the customer may be unable to personally receive the retail items and, instead, decide for the delivery agent 116 to deliver them into the portable retail container 200, the customer may communicate his/her decision to a retail store associated with the retail order and/or the delivery agent 116 via the electronic device 118. Alternatively or in addition to, the customer may modify the retail order, which updates the delivery instructions and/or the delivery destination provided to the delivery agent 116. Having the option of delivering retail items into the portable retail container 200 provides the benefit of convenient and secure delivery of retail items when the customer is, for example, at work. As such, a customer may have gained additional time for other activities by eliminating the need to stop at a retail store to shop for items, for example, needed by the customer to cook her/his dinner meal.

Moreover, the delivery agent 116 may remotely gain access to the vehicle 112 based on one or more access codes associated with the retail order. By one approach, the access codes may have been provided by the customer when the retail order was submitted or otherwise provided by the customer (e.g., at the time the customer submitted the request that the one or more items be delivered to the vehicle). By another approach, the access codes may be associated with a customer profile of the customer and accessible to the delivery agent and/or a retail entity directing the delivery. In yet another approach, the access codes may be provided by the customer or the control circuit 102 associated with the portable retail container 200 when the delivery agent 116 is at or near the vehicle 112 using a geofence associated with the vehicle 112. Thus, one or more of the access codes are used by the delivery agent 116 to gain access to the vehicle 112. In one configuration, the access codes are sent to the electronic device 118 associated with the delivery agent 116 by the control circuit 102 through a network 104. In another configuration, the access codes are sent to the electronic device 118 by a central control server (not shown) through the network 104. In yet another configuration, the access codes may be sent through the network 104 to the electronic device 118 in response to the electronic device 118 crossing a geofence associated with the portable retail container 200.

In one instance, the network 104 may comprise at least one of: a public network, a private network, and/or internet network, among other networks configured to couple one device to another device. In one configuration, the portable retail container 200 may include a transceiver 220 that is coupled to the control circuit 102. The access codes received by the electronic device 118 may be used to open the trunk 120. The transceiver 220 may receive at least one of the access codes. By one approach, the control circuit 102 may receive the access code and compare the access code to one of the access codes sent to the electronic device 118. If there is a match, the control circuit 102 may send a signal to an on-board remote access system 108 of the vehicle 112 indicating to unlock the trunk 120. If there is not a match, the control circuit 102 may send a message to the electronic device 118 indicating that access to the vehicle 112 has failed. Thus, the control circuit 102 may operably couple to the on-board remote access system 108 to unlock and/or lock the vehicle 112 and/or the trunk 120 via the on-board remote access system 108.

By one approach, the portable retail container 200 may be programmable by the customer (which may also be referred to as a user) to unlock and lock the vehicle 112 and/or the trunk 120. Programming of the portable retail container 200 may be performed by the customer via a display device 110 of the portable retail container 200. The display device 110 may be configured to receive input from the customer. In another instance, the customer may use an electronic device to program the portable retail container 200. The electronic device associated with the customer may operably couple to the transceiver 220 to program the portable retail container 200, such as through a software application executed on the customer electronic device providing an interface that allows the customer to interact with the portable retail container. The portable retail container 200 may unlock and/or lock one or more of the compartments 204, 206, the vehicle 112 and/or the trunk 120 through the control circuit 102.

Upon gaining access to the trunk 120, and thus access to the portable retail container 200, the delivery agent 116 may allocate the retail items to corresponding compartments of the portable retail container 200 based on one or more messages from the control circuit 102. By one approach, the control circuit 102 may send at least one message to the electronic device 118 of the delivery agent 116 indicating allocation of the retail items 212, 214 to the compartments 204, 206 based on an assignment of the retail items 212, 214. The assignment of the retail items 212, 214 to particular compartments 204, 206 by the control circuit 102 may be determined through a lookup database 122. By one approach, the control circuit 102 may also send an alert message to the electronic device 118 upon a determination that a retail item, based on an identification of the retail item through tag reader or other item identifier system, of the one or more retail items 212, 214 is incorrectly allocated in a compartment of the one or more compartments 204, 206.

In some embodiments, the system 100 may include a cloud-based database 106 that is operably coupled to the control circuit 102. The cloud-based database 106 may include the lookup database 122 storing an association of each of the plurality of retail items 212, 214 with at least one of: a temperature range of a plurality of temperature ranges or one of the one or more compartments 204, 206 of the portable retail container 200. In one configuration, the cloud-based database 106 may include an access code database 124. The access code database 124 may store access codes associated with a plurality of vehicle. By one approach, when the delivery agent 116 is in close proximity of the vehicle 112, the control circuit 102 may detect the electronic device 118 associated with the delivery agent 116 and access the access code database 124 to determine an access code associated with the vehicle 112 to unlock the trunk 120 and/or one or more doors of the vehicle 112. In one instance, the control circuit 102 may automatically unlock the trunk 120 and/or doors of the vehicle 112 in response to detecting the electronic device 118 of the delivery agent 116. In another instance, the control circuit 102 may provide the access code to the electronic device 118 to unlock the trunk 120 and/or the doors of the vehicle 112. Thus, for example, when the customer submits a retail order indicating the vehicle 112, the control circuit 102 may determine the access code particular to the vehicle 112 by accessing the access code database 124.

By one approach, the system 100 may include the control circuit 102 that may be coupled with the portable retail container 200. In one instance, the control circuit 102 may be integrated with the portable retail container 200 (as shown in FIG. 2). In another instance, the control circuit 102 may be operably coupled to the portable retail container 200 via the network 104. The control circuit 102 may also access the lookup database 122 to determine for each of the retail items 212, 214 at least one of: an associated temperature range or a compartment of the one or more compartments. By one approach, each of the compartments 204, 206 of the portable retail container 200 is associated with a particular assigned temperature range. For example, in the lookup database 122, a product associated with raw fish may be associated with a temperature between 30° F. to 32° F. range. As such, a compartment in the portable retail container 200 having a temperature between 32° F. to 30° F. may be conducive to properly storing the raw fish before consumption.

In one configuration, the control circuit 102 may assign the particular assigned temperature range to each of the compartments 204, 206 based on temperature ranges associated with the retail items 212, 214. As such, the control circuit 102 may also assign each of the retail items 212, 214 to a corresponding compartment 204, 206 based on the determined temperature range or the determined compartment. For example, continuing the illustrative, non-limiting example above, in addition to raw fish, a retail order may also include a package of raw chicken wings and a hot cooked rotisserie chicken. In the lookup database 122, a chicken product may be associated with a temperature danger zone ranging between 40° F. and 140° F. As such, a storage temperature falling within the temperature danger zone is considered unsafe for storing raw chicken. Thus, based on data accessed through the lookup database 122, the control circuit 102 may determine that raw chicken meat may be stored below 40° F. while cooked chicken meat may be stored above 140° F.

As such, in one instance, the control circuit 102 may assign a first temperature range of 30° F. to 32° F. to a first compartment and a second temperature range of 140° F. to 150° F. to a second compartment. Thus, the control circuit 102 may allocate the raw fish and the package of raw chicken wings to the first compartment and the hot cooked rotisserie chicken to the second compartment. By one approach, the control circuit 102 may have determined that the particular temperature range of 30° F. to 32° F. is a temperature range of a proper storage temperature for both the raw fish and the package of raw chicken wings based on information accessed from the lookup database 122. The information stored in the lookup database 122 may indicate that a proper storage temperature for raw fish is 30° F. to 32° F. while the temperature danger zone for chicken is between 40° F. and 140° F. By another approach, the control circuit 102 may have determined the particular temperature range of 30° F. to 32° F. by taking an average of each of the proper temperature storage associated with raw fish and chicken in the lookup database 122. Further, in an example where the portable retail container 200 may have three compartments, the control circuit 102 may, for example, determine to leave a third compartment unassigned and/or unallocated.

By another approach, for a particular model of the portable retail container 200, the lookup database 122 may store information associating each of the compartments of the particular model of the portable retail container 200 with a particular assigned temperature range. For example, continuing the illustrative, non-limiting example above, in the lookup database 122, the first compartment of the particular model may be associated with a temperature ranging between 20° F. to 35° F. while the second compartment may be associated with a temperature above 143° F. Based on the stored information in the lookup database 122, such as the temperature assignments for each compartment of the particular model and/or proper storage temperature associated with raw fish and raw and/or cooked chicken, the control circuit 102 may assign and/or allocate the raw fish and the package of raw chicken wings to the first compartment while the hot cooked rotisserie chicken to the second compartment.

In some embodiments, the control circuit 102 may determine a temperature of a particular compartment 204, 206 through a temperature read by the sensors 216, 218. The determined temperature for each of the compartments 204, 206 may be stored and associated with a particular portable retail container 200 in the cloud-based database 106. By one approach, the control circuit 102 may adjust the temperature associated with the particular compartment 204, 206 based on the particular assigned temperature and/or the determined temperature or temperature read by the one or more sensors 216, 218. By another approach, the temperature data associated with each of the compartments 204, 206 that is read overtime may be used by the control circuit 102 to readjust the temperature associated with the corresponding compartment in order to maintain the temperature within the particular assigned temperature.

In some embodiments, the system 100 may include the portable retail container 200 coupled to and powered by a car battery 114 of the vehicle 112. By one approach, the portable retail container 200 may receive power from at least the car battery 114. In one configuration, the control circuit 102 may determine whether a voltage output of the car battery 114 is sufficient to power the portable retail container 200 based on a comparison of the voltage output to a voltage threshold. In an illustrative non-limiting example, a voltage threshold may correspond to a predetermined voltage value of the car battery 114. The predetermined voltage value may have been previously determined (e.g., by the retail store, and/or manufacturer of the portable retail container 200, and/or battery manufacturer) to be sufficient to power the portable retail container 200. As such, the control circuit 102 may determine a voltage output of the car battery 114 at a particular time over a period of time. Thus, upon a determination of the control circuit 102 that the voltage output is less than the voltage threshold, the vehicle 112 may be started by the control circuit 102 to charge the car battery 114. By one approach, while charging, the control circuit 102 may periodically determine the voltage output of the car battery 114. By another approach, the control circuit 102 may turn the vehicle 112 off upon a determination that the voltage output is greater than the voltage threshold.

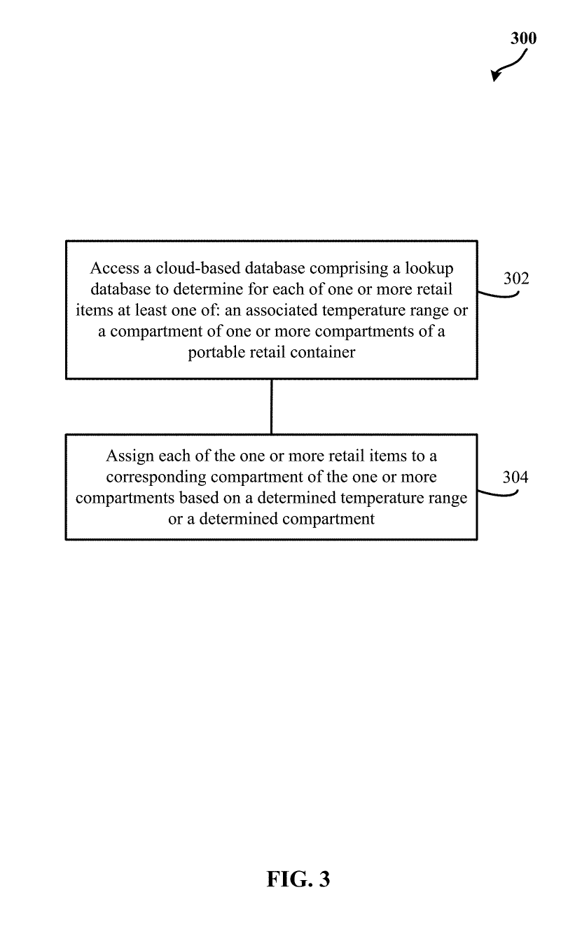

In FIG. 3, a flow diagram of an exemplary method 300 for receiving retail items at a vehicle in accordance with some embodiments is shown. The method 300 may be implemented in the system 100 of FIG. 1. By one approach, the method 300 may be implemented in the control circuit 102 of FIG. 1. The method 300 includes, at step 302, accessing, by a control circuit, a cloud-based database including a lookup database to determine for each of one or more retail items at least one of: an associated temperature range or a compartment of one or more compartments of a portable retail container. For example, in the lookup database, a retail item such as raw fish may be associated with an associated temperature range of 30° F. to 32° F. The stored associated temperature range for raw fish may be, for example, associated with an established industry standard for storing raw fish and/or a retail store's predetermined temperature range that is believed to be conducive to maintaining freshness of raw fish while in storage. In another example, the lookup database may store information associating a retail item with a particular compartment of a portable retail container. By one approach, each of the compartments of a portable retail container may be associated with a pre-assigned temperature range. Thus, in one instance, each of the one or more compartments may be associated with a particular assigned temperature range. In one configuration, the portable retail container may store the one or more retail items. The portable retail container may correspond to the portable retail container 200 of FIG. 1.

By one approach, the method 300 may include, at step 304, assigning, by the control circuit, each of the one or more retail items to a corresponding compartment of the one or more compartments based on the determined temperature range or the determined compartment. Continuing the illustrative non-limiting example above, the portable retail container may have two compartments. By one approach, based on the lookup database, the control circuit may have determined that there is a pre-assigned temperature range for each of the two compartments. A first compartment may have a pre-assigned temperature range between 30° F. to 35° F. while a second compartment may have a pre-assigned temperature of above 140° F. As such, the control circuit may assign a package of raw salmon steaks to the first compartment based on the associated temperature range of 30° F. to 32° F. for raw fish.

By another approach, there may not be a pre-assigned temperature range for each of the two compartments. As such, the control circuit may determine and/or assign a particular temperature range for each of the two compartments depending on the types/kinds of retail items to be allocated in the compartments. For example, the control circuit may determine that two assigments of separate temperature ranges are needed due to a retail order having the package of raw salmon steaks and a hot cooked rotisserie chicken. Thus, the control circuit may assign the first compartment to have a temperature range of 30° F. to 35° F. while the second compartment to have a temperature range of 140° F. to 165° F. As such, the control circuit may assign the package of raw salmon steaks to the first compartment while the hot cooked rotisserie chicken to the second compartment.

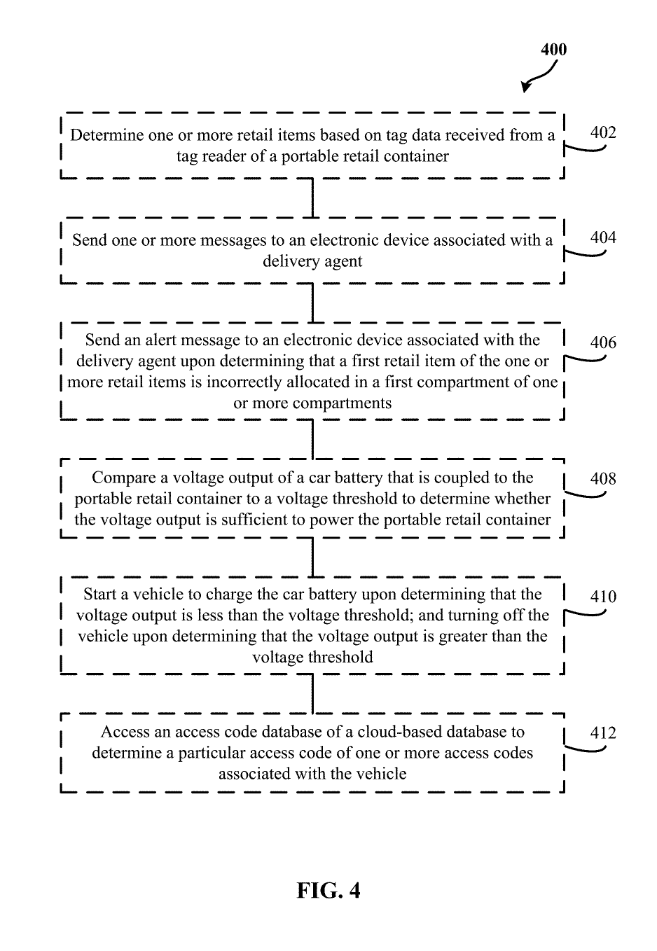

FIG. 4 shows a flow diagram of an exemplary method 400 for receiving retail items at a vehicle in accordance with some embodiments. The method 400 may be implemented in the system 100 of FIG. 1. By one approach, the method 400 may be implemented in the control circuit 102 of FIG. 1. By another approach, the method 400 and/or one or more steps of the method may optionally be included in and/or performed in cooperation with the method 300 of FIG. 3. The method 400 may include determining the one or more retail items based on tag data received from a tag reader of the portable retail container, at step 402. By one approach, the tag reader may be coupled to one or more reader antennas and wirelessly detect through the one or more reader antennas one or more tags each associated with one of the one or more retail items. By another approach, each one of the one or more reader antennas is associated with one of the one or more compartments. For example, continuing the example above, the tag reader may read, via an antenna associated with the first compartment, a tag associated with the package of raw salmon steaks that is placed in the first compartment; while a tag associated with the hot cooked rotisserie chicken is read by the tag reader via an antenna associated with the second compartment.

By one configuration, the method 400 may include sending one or more messages to an electronic device associated with the delivery agent, at step 404. The one or more messages may indicate allocation of the one or more retail items to the one or more compartments based on the assigning of each of the one or more retail items to the corresponding compartment. The method 400 may also include sending an alert message to an electronic device associated with the delivery agent upon determining that a first retail item of the one or more retail items is incorrectly allocated in a first compartment of the one or more compartments, at step 406. For example, instead of placing the package of raw salmon steaks in the first compartment, the delivery agent placed it in the second compartment. The control circuit may detect the incorrect placement based on the tag read by the tag reader. In response, the control circuit may send an alert message to an electronic device alerting the delivery agent regarding the incorrect placement.

By one approach, the method 400 may include comparing a voltage output of a car battery that is coupled to the portable retail container to a voltage threshold to determine whether the voltage output is sufficient to power the portable retail container, at step 408. The method 400 may also include starting the vehicle to charge the car battery upon determining that the voltage output is less than the voltage threshold; and turning off the vehicle upon determining that the voltage output is greater than the voltage threshold, at step 410. For example, the portable retail container may need to draw a particular voltage to operate. As such, the portable retail container may, in receiving power from a car battery, drain the car battery. Thus, to power the portable retail container, the car battery may need to output at least a particular voltage or a particular voltage threshold. As such, at one point in time, the output voltage of the car battery may fall below the particular voltage threshold. Upon determining that the voltage output is less than the particular voltage threshold, the control circuit may start the vehicle to charge the car battery and turn off when the charge of the car battery is at least or greater than the particular voltage threshold.

The method 400 may also include accessing an access code database of a cloud-based database to determine a particular access code of one or more access codes associated with the vehicle, wherein the particular access code unlocks at least one of: a trunk or one or more doors of the vehicle, at step 412. For example, the access code database 124 of FIG. 1 may store access codes associated with a plurality of vehicle. As such, in a customer profile associated with the customer, the customer may indicate type and model of the vehicle 112. By one approach, when the delivery agent 116 is in close proximity of the vehicle 112, the control circuit 102 may detect the electronic device 118 associated with the delivery agent 116 and access the access code database 124 to determine an access code associated with the vehicle 120 to unlock the trunk 120 or one or more doors of the vehicle 112.

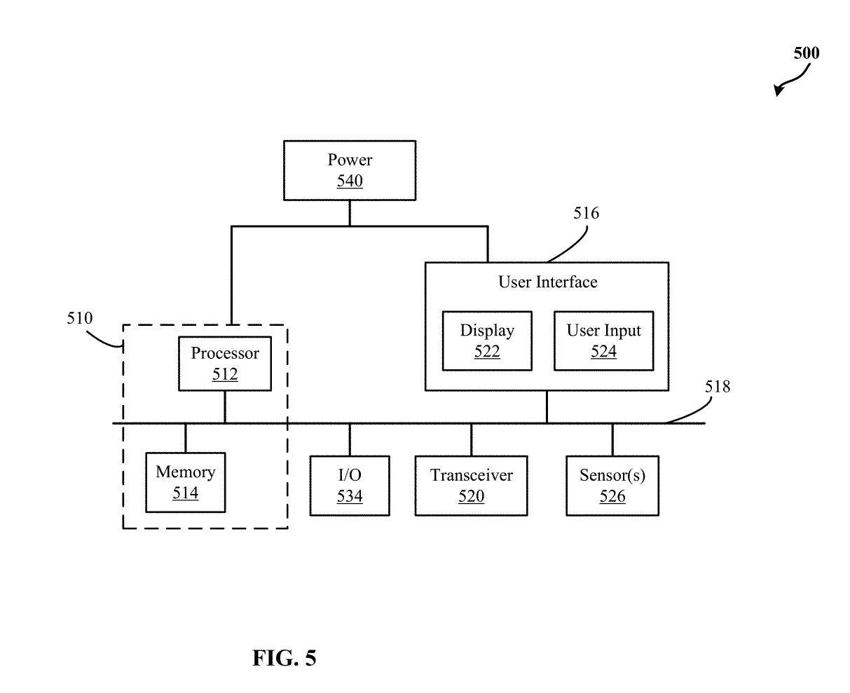

Further, the circuits, circuitry, systems, devices, processes, methods, techniques, functionality, services, servers, sources and the like described herein may be utilized, implemented and/or run on many different types of devices and/or systems. FIG. 5 illustrates an exemplary system 500 that may be used for implementing any of the components, circuits, circuitry, systems, functionality, apparatuses, processes, or devices of the system 100 of FIG. 1, the method 300 of FIG. 3, the method 400 of FIG. 4, and/or other above or below mentioned systems or devices, or parts of such circuits, circuitry, functionality, systems, apparatuses, processes, or devices. For example, the system 500 may be used to implement some or all of the system for receiving retail items at a vehicle 112, the cloud-based database 106, the on-board remote access system 108, the portable retail container 200, the control circuit 102, the electronic device 118, and/or other such components, circuitry, functionality and/or devices. However, the use of the system 500 or any portion thereof is certainly not required.

By way of example, the system 500 may comprise a processor module (or a control circuit) 512, memory 514, and one or more communication links, paths, buses or the like 518. Some embodiments may include one or more user interfaces 516, and/or one or more internal and/or external power sources or supplies 540. The control circuit 512 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 512 can be part of control circuitry and/or a control system 510, which may be implemented through one or more processors with access to one or more memory 514 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 500 may be used to implement one or more of the above or below, or parts of, components, circuits, systems, processes and the like. For example, the system 500 may implement the system for receiving retail items 212, 214 with the control circuit 102 being the control circuit 512.

The user interface 516 can allow a user to interact with the system 500 and receive information through the system. In some instances, the user interface 516 includes a display 522 and/or one or more user inputs 524, such as buttons, touch screen, track ball, keyboard, mouse, etc., which can be part of or wired or wirelessly coupled with the system 500. Typically, the system 500 further includes one or more communication interfaces, ports, transceivers 520 and the like allowing the system 500 to communicate over a communication bus, a distributed computer and/or communication network (e.g., a local area network (LAN), the Internet, wide area network (WAN), etc.), communication link 518, other networks or communication channels with other devices and/or other such communications or combination of two or more of such communication methods. Further the transceiver 520 can be configured for wired, wireless, optical, fiber optical cable, satellite, or other such communication configurations or combinations of two or more of such communications. Some embodiments include one or more input/output (I/O) interface 534 that allow one or more devices to couple with the system 500. The I/O interface can be substantially any relevant port or combinations of ports, such as but not limited to USB, Ethernet, or other such ports. The I/O interface 534 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 526 to provide information to the system and/or sensor information that is communicated to another component, such as the central control system, a portable retail container, a vehicle associated with the portable retail container, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 500 comprises an example of a control and/or processor-based system with the control circuit 512. Again, the control circuit 512 can be implemented through one or more processors, controllers, central processing units, logic, software and the like. Further, in some implementations the control circuit 512 may provide multiprocessor functionality.

The memory 514, which can be accessed by the control circuit 512, typically includes one or more processor readable and/or computer readable media accessed by at least the control circuit 512, and can include volatile and/or nonvolatile media, such as RAM, ROM, EEPROM, flash memory and/or other memory technology. Further, the memory 514 is shown as internal to the control system 510; however, the memory 514 can be internal, external or a combination of internal and external memory. Similarly, some or all of the memory 514 can be internal, external or a combination of internal and external memory of the control circuit 512. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 514 can store code, software, executables, scripts, data, content, lists, programming, programs, log or history data, user information, customer information, product information, and the like. While FIG. 5 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for receiving retail items at a vehicle comprising:
a portable retail container configured to store one or more retail items delivered by a delivery agent; and operably coupled to the vehicle, wherein the portable retail container comprises one or more compartments;
a cloud-based database comprising a lookup database and operably coupled to a control circuit, the lookup database storing, for each of the plurality of retail items, an association with at least one of: a temperature range of a plurality of temperature ranges, or one of the one or more compartments of the portable retail container; and
the control circuit coupled with the portable retail container, the control circuit configured to:
access the lookup database to determine for each of the one or more retail items at least one of: an associated temperature range or a compartment of the one or more compartments, wherein each of the one or more compartments is associated with a particular assigned temperature range; and
assign each of the one or more retail items to a corresponding compartment of the one or more compartments based on the determined temperature range or the determined compartment.

2. The system for receiving retail items of claim 1, wherein the portable retail container further comprises:
one or more reader antennas with at least one of the one or more reader antennas being associated with each of the one or more compartments; and
a tag reader coupled with the one or more reader antennas and configured to wirelessly detect through the one or more reader antennas one or more tags each associated with one of the one or more retail items.

3. The system for receiving retail items of claim 1, wherein the control circuit is operably coupled to an on-board remote access system of the vehicle and further configured to unlock or lock the vehicle via the on-board remote access system.

4. The system for receiving retail items of claim 1, wherein the portable retail container comprises a display device configured to receive input from a user of the vehicle, the portable retail container programmable by the user to unlock and lock the vehicle, and wherein the programming of the portable retail container is performed by the user via at least one of an electronic device associated with the user or the display device.

5. The system for receiving retail items of claim 1, wherein the control circuit is further configured to:
assign the particular assigned temperature range to each of the one or more compartments based on temperature ranges associated with the one or more retail items;
determine a temperature of a particular compartment of the one or more compartments; and
adjust the temperature of the particular compartment based on the particular assigned temperature range.

6. The system for receiving retail items of claim 1, wherein the control circuit is further configured to send one or more messages to an electronic device associated with the delivery agent, and wherein the one or more messages indicate allocation of the one or more retail items to the one or more compartments based on the assignment of the one or more retail items.

7. The system for receiving retail items of claim 1, wherein the control circuit is further configured to send an alert message to an electronic device associated with the delivery agent upon a determination that a first retail item of the one or more retail items is incorrectly allocated in a first compartment of the one or more compartments.

8. The system for receiving retail items of claim 1, wherein the portable retail container is coupled to and powered by a car battery of the vehicle, and wherein the control circuit is further configured to determine whether a voltage output of the car battery is sufficient to power the portable retail container based on a comparison of the voltage output to a voltage threshold.

9. The system for receiving retail items of claim 8, wherein the control circuit is further configured to:
start the vehicle to charge the car battery upon a first determination that the voltage output is less than the voltage threshold; and
turn off the vehicle upon a second determination that the voltage output is greater than the voltage threshold.

10. A method for receiving retail items at a vehicle comprising:
accessing, by a control circuit, a cloud-based database comprising a lookup database to determine for each of one or more retail items at least one of: an associated temperature range or a compartment of one or more compartments of a portable retail container, wherein each of the one or more compartments is associated with a particular assigned temperature range, and wherein the portable retail container is configured to store the one or more retail items; and
assigning, by the control circuit, each of the one or more retail items to a corresponding compartment of the one or more compartments based on the determined temperature range or the determined compartment.

11. The method of claim 10, further comprising determining the one or more retail items based on tag data received from a tag reader of the portable retail container, wherein the tag reader is coupled to one or more reader antennas and wirelessly detect through the one or more reader antennas one or more tags each associated with one of the one or more retail items, and wherein each one of the one or more reader antennas is associated with one of the one or more compartments.

12. The method of claim 10, further comprising sending one or more messages to an electronic device associated with a delivery agent, wherein the one or more messages indicate allocation of the one or more retail items to the one or more compartments based on the assigning of each of the one or more retail items to the corresponding compartment.

13. The method of claim 10, further comprising sending an alert message to an electronic device associated with a delivery agent upon determining that a first retail item of the one or more retail items is incorrectly allocated in a first compartment of the one or more compartments.

14. The method of claim 10, further comprising comparing a voltage output of a car battery that is coupled to the portable retail container to a voltage threshold to determine whether the voltage output is sufficient to power the portable retail container.

15. The method of claim 14, further comprising: starting the vehicle to charge the car battery upon determining that the voltage output is less than the voltage threshold; and turning off the vehicle upon determining that the voltage output is greater than the voltage threshold.

16. The method of claim 10, further comprising accessing an access code database of a cloud-based database to determine a particular access code of one or more access codes associated with the vehicle, wherein the particular access code unlocks at least one of: a trunk or one or more doors of the vehicle.

17. A system for receiving retail items at a vehicle comprising:
a portable retail container comprising one or more compartments and operably coupled to the vehicle, the portable retail container configured to:
store one or more retail items delivered by a delivery agent; and
receive power from a car battery of the vehicle; and
a control circuit coupled with the portable retail container, the control circuit configured to:
access a lookup database to determine for each of the one or more retail items at least one of: an associated temperature range or a compartment of the one or more compartments, wherein each of the one or more compartments is associated with a particular assigned temperature range;
assign each of the one or more retail items to a corresponding compartment of the one or more compartments based on the determined temperature range or the determined compartment; and
determine whether a voltage output of the power received from the car battery is sufficient to power the portable retail container based on a voltage threshold.

18. The system for receiving retail items of claim 17, wherein the portable retail container further comprises:
one or more reader antennas with at least one of the one or more reader antennas being associated with each of the one or more compartments; and
a tag reader coupled with the one or more reader antennas and configured to wirelessly detect through the one or more reader antennas one or more tags each associated with one of the one or more retail items.

19. The system for receiving retail items of claim 17, wherein the control circuit is further configured to:
assign the particular assigned temperature range to each of the one or more compartments based on temperature ranges associated with the one or more retail items;
determine a temperature of a particular compartment of the one or more compartments; and
adjust the temperature of the particular compartment based on the particular assigned temperature range.

20. The system of claim 17, wherein the control circuit is further configured to:
start the vehicle to charge the car battery upon a first determination that the voltage output is less than the voltage threshold; and
turn off the vehicle upon a second determination that the voltage output is greater than the voltage threshold.
